(19) United States
(12) Patent Application Publication
(10) Pub. No.: US 2008/0041649 A1
(43) Pub. Date: Feb. 21, 2008

(54) Automotive reservoir with integrated through-the-wall fitting and method for making same

(75) Inventor: Raymond Ng, Dearborn Heights, MI (US)

Correspondence Address: YOUNG & BASILE, P.C., 3001 WEST BIG BEAVER ROAD, SUITE 624, TROY, MI, 48084, US

(73) Assignee: NISSAN TECHNICAL CENTER NORTH AMERICA, INC., Farmington Hills, MI (US)

(21) Appl. No.: 11/503,560

(22) Filed: Aug. 11, 2006

(51) Int. Cl. B60K 15/00

(52) U.S. Cl. 180/69.4

(57) ABSTRACT

A reservoir for use in an automotive vehicle including at least one plastic wall region and at least one through-the-wall fitting element fused to the plastic wall. The through-the-wall fitting has an outer polymeric face in contact with the plastic wall. At least one of the outer polymeric face of the through-the wall fitting and the plastic wall proximate to the through-the-wall element contain particulate suspector material integrated therein. A method of making the same is also disclosed.

### BACKGROUND

The present invention pertains to plastic containers employed in automotive vehicles. More particularly, the present invention pertains to plastic containers such as fuel tanks having at least one auxiliary apparatus integrally joined to the plastic wall of the structure and methods for making the same.

Automotive vehicles such as passenger cars, light trucks, and various other devices employ various reservoirs or containers for operational fluids. Nonlimiting examples of such plastic reservoirs include fuel tanks, washer fluid reservoirs, radiator fluid reservoirs and the like. Such containers need to be essentially fluid tight. For various reasons these reservoirs can be made in whole or in part of plastic materials.

The various containers employed in automotive vehicles include suitable apertures for ingress and egress of fluids. Additionally, the containers can include suitable auxiliary devices such as valves, sensors and the like which are mounted in fluid-tight relationship to the container wall. For purposes of this discussion, these will be collectively referred to as through-the-wall fitting elements.

In order to function efficiently, the various valves, fluid ingress and egress orifices and sensors must be mounted in a robust fluid tight manner. Thus, it is important to achieve a robust seal between the walls of the reservoir and the associated through-the-wall fitting elements.

Heretofore, various adhesives and mounting methods have been suggested. Additionally, the method for assembling the tank or reservoir device with the appropriate through-the-wall fitting elements is, ideally, one that can be achieved with speed and accuracy to facilitate rapid assembly of the finished reservoir. Heretofore, various adhesive methods have been employed. These include the interposition of various glues, mounts and adhesives between reservoir wall and fitting element. It has also been suggested to provide plastic through-the-wall fitting elements in which a suitable heating wire is mounted in the plastic body. Introduction of current into the heating wire causes localized melting of the plastic body. Application of the through-the-wall fitting element such a vent or valve onto the surface of the plastic walls with suitable pressure causes the associated region of the plastic reservoir wall to melt, permitting insertion of the fitting element through the associated plastic region. Once the valve is in position, current is discontinued and the plastic in the two respective bodies is allowed to resolidify in fused relationship.

There exists a continuing need for various processes and devices that achieve and maintain robust seals between the reservoir body and the desired fitting element. Additionally, there exists a continuing need for developing assembly processes that can produce reservoirs suitable for use in automotive vehicles in efficient and effective manners.

### SUMMARY

Disclosed herein is a reservoir for use in an automotive vehicle. Suitable non-limiting examples of such reservoirs include fuel tanks, radiator fluid reservoirs, windshield washer fluid reservoirs and the like. The reservoir for use in an automotive vehicle as disclosed herein includes at least one plastic wall region and at least one through-the-wall fitting element fused to the plastic wall. The through-the-wall fitting has an outer polymeric face in contact with the plastic wall. At least one of the outer polymeric face of the vent and the plastic wall proximate to the through-the-wall element contain suspector material integrated therein.

Also disclosed herein is a method for assembling a reservoir for use in an automotive vehicle. The method includes the steps of contacting a localized area of a plastic wall section of the reservoir with the polymeric surface of a through-the-wall fitting element wherein at least one of the polymeric surface of the through-the-wall fitting element and the localized area of the plastic wall contains suspector material. The method also includes the step of exposing the through-the-wall fitting element and the plastic wall section to electromagnetic radiation for an interval sufficient to cause melting of the polymeric material adjacent to suspector material and permitting the material of the polymeric surface of the through-the-wall fitting element and the plastic wall section to solidify in fused contact with each other.

### DESCRIPTION OF THE DRAWING

The description herein makes reference to the accompanying drawings wherein like reference numerals refer to like parts throughout the several views and wherein:

FIG. 1 is a perspective exploded view of an embodiment of a reservoir as disclosed herein;

FIG. 2 is a cross-sectional view of the end embodiment of the reservoir as disclosed herein with a through-the-wall fitting element in position;

FIG. 3 is a detail view of FIG. 2;

FIG. 4 is a process diagram of one embodiment of the assembly process disclosed herein;

FIGS. 5a through 5c are schematic depictions of process steps in an embodiment of the assembly process as disclosed herein.

### DETAILED DESCRIPTION

Disclosed herein is a vessel or reservoir for use in an automotive vehicle. It is contemplated that the reservoir can be any suitable device of which fuel tanks, windshield washer fluid reservoirs, radiator fluid reservoirs and the like are nonlimiting examples. The automotive reservoir generally includes at least one plastic wall and at least one through-the-wall fitting element in sealed contact with the plastic wall. At least one of the through-the-wall fitting element and the plastic wall contain particulate suspector material in the region proximate to the junction between the through-the-wall fitting element and the plastic wall. Also disclosed herein is a method for making the same.

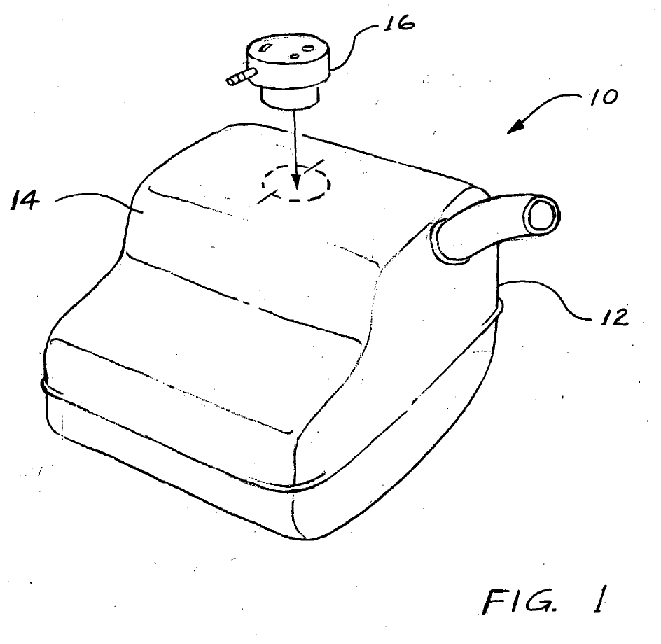

As depicted herein, the reservoir 10 is a fuel tank that includes at least one plastic wall 14 with at least one through-the-wall fitting element 16 fused to plastic wall 14. An embodiment as depicted in FIG. 1, may include multiple molded plastic wall members joined together to form a reservoir. In an embodiment as depicted in FIG. 1, the reservoir can be a fuel tank such as fuel tank 12.

As used herein, it is contemplated that the through-the-wall fitting element 16 can be any suitable device or fitting used in conjunction with the automotive reservoir such as fuel tank 12. Nonlimiting examples of such devices include vents, valves, sensors, access ports, and the like. It is understood that other suitable through-the-wall fitting elements can be employed in connection with the reservoir 10 disclosed herein as desired or required.

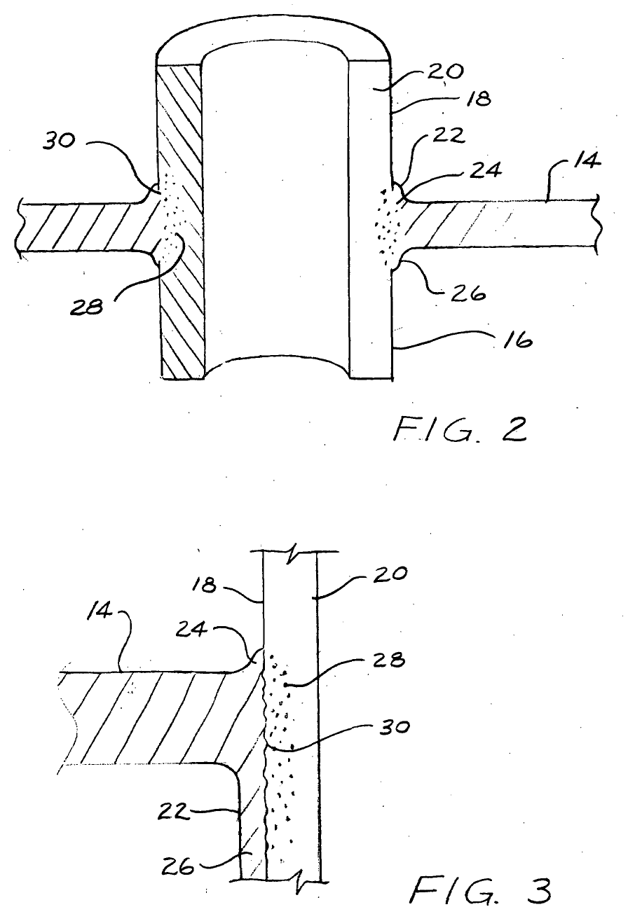

The through-the-wall fitting element 16 may have any suitable configuration. Element 16 has an outer polymeric face 18, configured to extend along the outer periphery of element 16 at a location that corresponds to the junction with plastic wall 14. In an embodiment as depicted in FIGS. 1-3, the polymeric face 18 extends around the outer circumferential periphery of the through-the-wall fitting element 16 in a tubular manner. It is to be understood that other configurations and geometries can be employed. As depicted, the polymeric face 18 is integral to a tubular body 20. It is contemplated that the polymeric face 18 can be part of a distinct layer or integral to the associated substance as desired or required.

The plastic wall 14 of reservoir 10 includes a region 22 proximate to through-the-wall fitting element 16 in the assembled or use condition. The plastic wall 14 has a thickness suitable for end use application. As depicted the region 22 proximate to through-the-wall fitting element 16 has upper and lower flange members 24, 26. Region 22 may have any geometry suitable to support and maintain element 16 in position.

At least one of the outer polymeric face 18 and the region 20 have a suspector material 28 contained therein. The suspector material 28 may be integrated into one or both of the polymeric face 18 and plastic wall region 22 in any suitable manner. One nonlimiting example of particle integration involves embedding suspector material in a generally random dispersed manner throughout the desired region. In an embodiment as depicted in FIGS. 1-3, the suspector material 28 is integrated into outer polymeric face 18 of through-the-wall fitting element 16. Where desired or required, the suspector material 28 may be concentrated proximate to the outer surface of the polymeric wall 18 of through-the-wall fitting element 16 at a depth and concentration suitable to facilitate localized melting of the polymeric material proximate to the outer surface upon exposure with electromagnetic radiation.

The through-the-wall fitting element 16 may include other suitable structural and functional elements as desired or required. These include, but are not limited to, vent mechanisms, valve mechanisms, sensor devices, etc.

As used herein, the term “suspector material” is taken to mean materials that are capable of producing heat upon exposure to electromagnetic fields. Suspector material may be present as particles integrated into the surrounding polymeric material. It is contemplated that the suspector material 28 can be any suitable particulate material that reacts in any suitable electromagnetic wave region such as, for example, a frequency of 0.5 GHz to about 10 GHz to generate heat sufficient to cause localized melting of the polymeric matrix in which it is integrated. The term “integrated” is taken to mean that the suspector material is incorporated into the surrounding polymeric matrix by any suitable method. For example, the particles may be suspended or embedded in the surrounding polymeric material, generally in a random dispersed manner. In an embodiment as disclosed herein, the suspector material 28 is integrated into the polymeric material so as to maintain the temperature of polymeric material outside the integration zone below the glass transition temperature T_{g} and/or the melt point Tₘ of the polymer.

Nonlimiting examples of suitable suspector materials include carbon black, fine iron particles, fine magnetic iron oxide, mixtures of iron and magnetic iron oxide, gold silver, powdered magnetic ceramic materials and the like. Ceramic materials, when employed, can include at least one metal such as refractory metals including, but not limited to, titanium, vanadium, chromium, zirconium, niobium, molybdenum, hafnium, tantalum, and tungsten. It is also contemplated that the suspector material can be a magnetic alloy particle that includes a transition metal such as iron and/or cobalt. The alloy particles may further include materials such as nickel and/or aluminum or other alloying additions in order to provide desired electromagnetic absorption characteristics.

Without being bound to any theory, it is believed that suspector particles integrated into the surrounding polymeric material produce heat in response to exposure to electromagnetic radiation due to a phenomenon such as hysteresis and/or eddy effects. The suspector particles can have any suitable size, with particle sizes from sub-micron to approximately 1,000 microns or greater being typical. Where desired or required, the integrated particles can be of essentially uniform size. However particles of varying size can be integrated into the polymeric material as desired or required. Without being bound to any theory, it is believed that variation in particle size can be employed to achieve either hysteresis or eddy current heating at a variety of different frequencies thereby maximizing and/or tuning the heating and polymer melting process. The suspector particles can be any shape that permits efficient heating of the polymeric material. Thus, the materials can be spherical, flake, disc or the like.

The reservoir 10 with through-the-wall fitting element 16 incorporated therein may also include a weld zone 30 located between the through-the-wall fitting element 16 and the wall 14. The weld zone, as the term is used herein, is a region of fusion between the polymeric material of the polymeric face 18 of the through-the-wall fitting element 16 and the polymeric material of the plastic wall 14. In an embodiment as depicted in FIGS. 1-3, it is contemplated that the weld zone 30 extends into the polymeric material for a short distance beyond the suspector and extends into the corresponding plastic wall region 24 for a suitable range. A nonlimiting example of this range would be from about 5 to about 20 mils from the actual point of infusion.

It is contemplated that the plastic wall 14 of reservoir 10 can be composed of any suitable polymeric material. Nonlimiting examples of materials employed in fuel tanks include high-density polyethylene, ethylene vinyl alcohol, and mixtures thereof. High density polyetheylenes suitable for use in embodiments as disclosed herein include but are not limited to linear crystalline polyethylene and EVOH suitable for use in applications such as fuel tanks. It is contemplated such material may be virgin or regrind and may be incorporated as blends of various materials depending upon final end use performance characteristics. Nonlimiting examples of materials and grades that are commercially available include high-density polyethylenes such as Lupolen 4261, commercially available from BASF; adhesive high-density polyethylene, commercially available from Mitsui under the trade designation GT6A; and ethylene vinyl alcohol polymers, commercially available from Evalca. It is to be understood that other suitable polymeric materials can be employed for all or part of the reservoir 10.

Typically, the material of choice will be one that has a melting temperature Tₘ in a range below the melting temperature for the polymeric material employed in polymeric wall 18 of through-the-wall fitting element 16. While the present disclosure is not to be limited to any specific temperature differential range, it is contemplated that a melt temperature differential range between 5 and 100° C. can be effectively utilized. Thus, it is contemplated that the polymeric material employed in the plastic wall 14 can have a melting point in the range of 110° C. to 160° C. (for HDPE) or 160° to 180° C. (for EVOH copolymers) as determined by a suitable method such as DSC peak endothermic measuring conditions, with glass transition temperatures in the range of 50 to 70° C. for EVOH copolymers measured by dynamic viscoelasticity methods

The through-the-wall fitting element 16 can be composed of any suitable material and be configured in any suitable orientation or configuration as desired or required. It is contemplated that the vent element will include a polymeric face 18 containing a polymeric material composed, at least in part, of a polymer having a melt temperature Tₘ between 5 and 100° C. above the melt temperature of the plastic wall region 20 proximate to the polymeric face 18. Nonlimiting examples of suitable polymeric and/or copolymeric materials are acetal resins known variously as polyoxyalkylenes, polyacetals, and paraformaldehydes. Various polyoxyalkylenes can be employed, of which polyoxymethylene is one nonlimiting example. Nonlimiting examples of suitable acetal resin materials are those distributed under the tradenames DELRIN, CELCON, and ULTRAFORM, typically having a melt temperature between 180° and 220° C.

While the suspector material 28 can be positioned in either the plastic wall region 28 proximate through-the-wall fitting element 16 or in the polymeric wall 18 of element 16 in some embodiments, it is contemplated that the suspector material 28 can be advantageously integrated into the higher melting material and concentrated in regions proximate the outer surface of that element. The concentration of suspector material proximate to the outer surface of the respective plastic material will be that sufficient to achieve localized melting of the polymeric material with the temperature elevation achieved sufficient to initiate localized melting of the plastic wall 14 proximate to the vent element 16.

In its assembled configuration, it is contemplated that the polymeric face 18 of through-the-wall fitting element 16 and plastic wall 14 of reservoir 10 will form a junction whereby the respective polymeric materials exist in a fused bonded relationship. The junction exhibits at least one of chemical bonding, mechanical bonding, or the like. In an embodiment of this reservoir 10, it is contemplated that the junction will exhibit characteristics associated with localized melting of the material in the polymeric face 18 and the region on the plastic wall 14 proximate to the polymeric face 18.

The junction can include suitable shoulders formed in the plastic wall region proximate to the through-the-wall fitting element 16. Circumferential shoulders can provide reinforcement and additional surface bonding area where desired or required. It is contemplated that such shoulders can be formed from geometric features already existing in the plastic wall or can be produced during the reservoir assembly process, namely during the through-the-wall fitting element 16 insertion process.

The through-the-wall fitting element 16 can be inserted into plastic wall 14 of the reservoir 10 and bonded thereto by any suitable process. An embodiment of such assembly process includes the steps of contacting a localized area of plastic wall 14 of reservoir 10 with the polymeric wall 18 of through-the-wall fitting element 16. At least one of the polymeric wall 18 of through-the-wall fitting element 16 and plastic wall region 22 of plastic wall 14 contain suspector material 28. Once the plastic wall 14 has been contacted by the through-the-wall fitting element 16, they are exposed to electromagnetic radiation such that localized melting of polymeric material in the through-the-wall fitting element 16 and plastic wall region 22 of the fuel tank occurs. The melted regions of the polymeric surface 18 and plastic wall 14 are allowed to solidify in fused contact with one another such that the vent element 16 is an integral part of plastic wall 14.

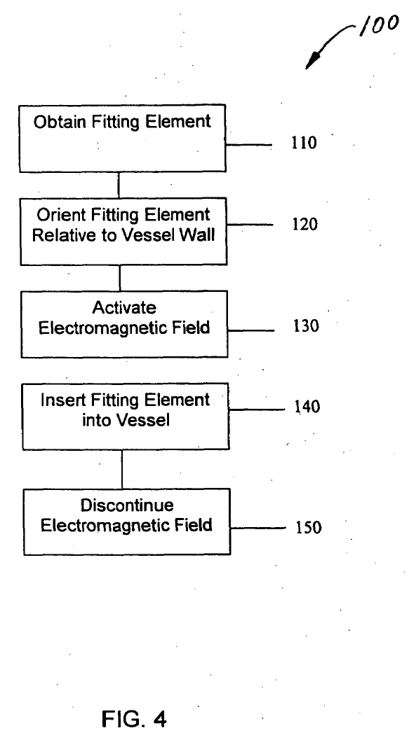

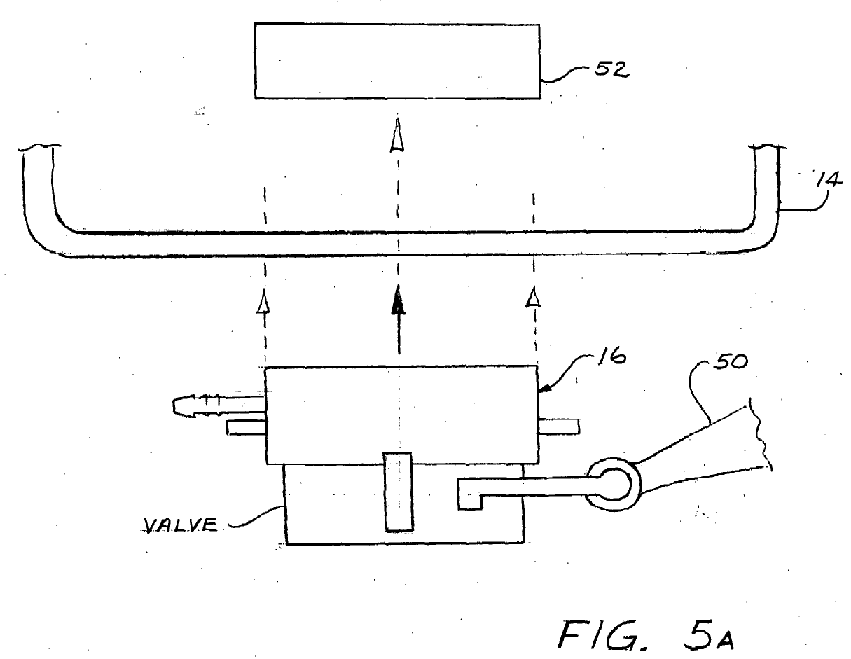

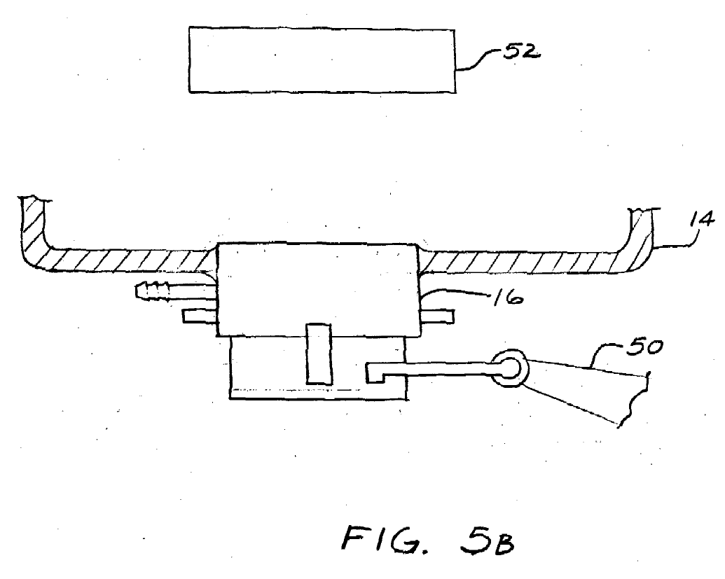

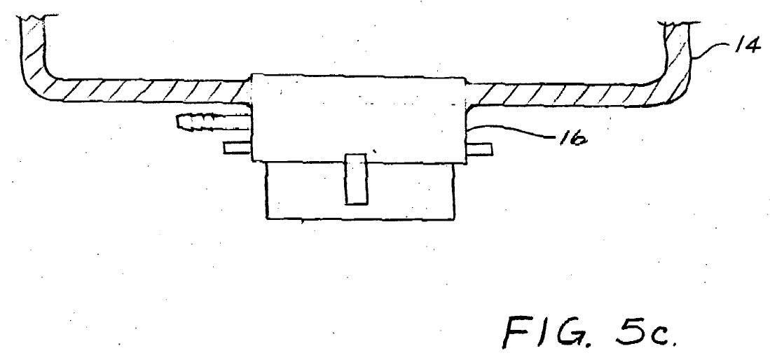

As depicted in FIG. 4, the assembly method 100 broadly includes the steps of obtaining a through-the-wall fitting element such as element 16 as at reference step 110. The through-the-wall fitting element such as fitting element 16 can be suitably configured and collected for assembly in the assembly/insertion process. It is contemplated that the through-the-wall fitting element 16 will be transported by a suitable mechanism such as robotic arm 50 shown in FIGS. 5A and 5B. In the process described herein, the through-the-wall fitting element 16 will be oriented and positioned relative to plastic wall 14 of the reservoir 10 at a suitable stage in the reservoir assembly process as shown at reference numeral 120. Depending on the particulars of the assembly process, it is contemplated that the through-the-wall fitting element 16 can be positioned relative to the ultimate interior or exterior of the reservoir 12 and assembled from that point.

When in position, the through-the-wall fitting element 16 is brought into contact with the surface of plastic wall 14. The respective components are exposed to an electromagnetic field as at reference numeral 130. The electromagnetic field is one sufficient to interact with suspector material 28 integrated in the polymeric material of at least one of the components, resulting in temperature elevation of the suspector material 28 and localized melting of proximate polymeric material. Exposure to the electromagnetic field can occur during or subsequent to the completion of the orientation step 120. The electromagnetic field can be generated by any suitable device such as electromagnetic field generator 52.

Once the electromagnetic field has been activated, the polymeric material containing integrated suspector 28 is permitted to melt. In an embodiment as depicted herein, it is contemplated that the suspector material 28 is integrated into the polymeric material with the higher melt temperature as in the through-the-wall fitting 16. The melt temperature of the polymer is such that action of the robotic arm 50 urging the through-the-wall fitting 16 into contact with the plastic wall 14 causes the polymeric material of the plastic wall proximate to the through-the-wall fitting 16 to melt and give way permitting insertion of the through-the-wall fitting 16. The through-the-wall fitting element 16 can be inserted through the plastic wall 14, typically by action of robotic arm 50. The elevated temperature associated with fitting 16 triggers a temperature rise in the contacted plastic wall 14 causing the material to melt. Pressure on the melting plastic wall 14 permits the fitting 16 to be inserted therein as at reference numeral 140.

Once the fitting element 16 is inserted into wall 14, the electromagnetic field can be discontinued as at reference numeral 150. The perfected polymeric material can be allowed to cool into fused relation with one another and the robotic arm 50 released from contact with the through-the-wall fitting 16.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed:

1. A reservoir for use in an automotive vehicle comprising:
at least one plastic wall; and
at least one through-the-wall fitting element fused to the plastic wall, the through-the-wall fitting element having an outer polymeric face in contact with the plastic wall,
wherein at least one of the outer polymeric face and the plastic wall have particulate suspector material contained therein.

2. The reservoir of claim 1 wherein the particulate suspector material emits heat upon exposure to electromagnetic radiation, resulting in localized melting of material in the outer polymeric face and plastic wall proximate to the outer polymeric face.

3. The reservoir of claim 1 wherein the plastic wall contains at least one of polyethylene, polypropylene, polyamide, polyketone, and polyester.

4. The reservoir of claim 3 wherein the polyethylene is selected from the group consisting of high density polyethylene, low density polyethylene, linear low density polyethylene, and mixtures thereof.

5. The reservoir of claim 1 wherein the suspector material is a particulate material dispersed in at least one of the outer polymeric face and the plastic wall, the particulate material emitting heat upon exposure to electromagnetic radiation resulting in localized melting of material in the outer polymeric face and plastic wall proximate to the outer polymeric face.

6. The reservoir of claim 1 wherein the particulate suspector material is at least one of carbon black, iron, magnetic iron oxide, mixtures of iron and magnetic iron oxide, gold, silver, and powdered magnetic ceramic materials.

7. The reservoir of claim 1, wherein the at least one plastic wall is configured as a member of a fuel tank and the through-the wall fitting is at least one of a vent or valve.

8. The fuel tank of claim 7 wherein the suspector material is a particulate material dispersed in the outer polymeric face of the through-the-wall fitting element, the particulate material emitting heat upon exposure to electromagnetic radiation resulting in localized melting of material in the outer face and plastic wall proximate to the outer polymeric face.

9. A method of producing the fuel tank having a plastic wall and at least one through-the-wall fitting element positioned therein, the method comprising the steps of:
contacting an area of the plastic wall of the fuel tank with a polymeric face of a through-the-wall fitting element, wherein at least one of the polymeric face of the through-the-wall fitting element and an area of the plastic wall proximate to the point of contact has particulate suspector material embedded in a polymeric matrix;
exposing the suspector material to electromagnetic radiation sufficient to trigger localized melting of polymeric matrix proximate to the suspector material; and
allowing the polymeric face and the plastic wall to solidify in fused contact with each other.

10. The method of claim 9 wherein the contacting step comprises orienting the through-the-wall fitting element relative to the plastic wall using a robotic arm.

11. The method of claim 9 wherein the plastic wall contains a first polymeric material having a first melt temperature and the polymeric face contains a second polymeric material having a second melt temperature, wherein the first melt temperature is lower that the second melt temperature.

12. The method of claim 11 wherein the first polymeric material contains at least one of polyethylene, polypropylene, polyamide, polyketone, and polyester and the second polymeric material contains an acetal resin.

13. The method of claim 11 wherein the particulate suspector material is integrated into the polymeric surface in a random dispersed manner.

14. The method of claim 13 wherein the suspector material emits heat upon exposure to electromagnetic radiation resulting in localized melting of material in the outer polymeric surface and plastic wall proximate to the outer polymeric surface.

15. The method of claim 13 wherein the suspector material is at least one of carbon black, iron, magnetic iron oxide, mixtures of iron and magnetic iron oxide, gold, silver, and powdered magnetic ceramic materials.

16. An automotive vehicle comprising a fuel tank, the fuel tank including at least one plastic wall and at least one through-the-wall fitting element fused to the plastic wall, the through-the-wall fitting element having an outer polymeric face in contact with the plastic wall, wherein at least one of the outer polymeric face and the plastic wall have particulate suspector material contained therein.
